(19) United States
(12) Patent Application Publication
(10) Pub. No.: US 2013/0013361 A1
(43) Pub. Date: Jan. 10, 2013

(54) SOFTWARE THAT MATCHES PEOPLE AND COMPANIES BASED ON THE STATED CORE VALUES OF BOTH PARTIES

(76) Inventor: Michael Frazier, Augusta, GA (US)

(21) Appl. No.: 13/544,649

(22) Filed: Jul. 9, 2012

Related U.S. Application Data
(60) Provisional application No. 61/506,040, filed on Jul. 9, 2011.

(51) Int. Cl. G06Q 10/06

(52) U.S. Cl. 705/7.14

(57) ABSTRACT

A method of matching employers to candidates receives core values from both employers and prospective candidates and then uses these core values to match the employers and candidates.

### CROSS-REFERENCE TO RELATED APPLICATION

This application claims the benefit of priority of U.S. provisional application No. 61/506040, filed Jul. 09, 2011, the contents of which are herein incorporated by reference.

### BACKGROUND OF THE INVENTION

The present invention relates to hiring employees and, more particularly, to software for matching the core values of employers to employees.

Existing practices for hiring employees or contractors typically focus on matching the skill set of a prospective candidate to the required skill set for the job. While this method works well for finding an employee that has the tools to succeed, many times new employees are dissatisfied with the new job that they have accepted. Similarly, employers are dissatisfied with the performance of the new hire. This type of candidate mismatch can be traced to a behavioral or cultural mismatch between the employee and the new hire.

When the candidate's perception of acceptable behavior and their general belief system when it comes to contributing as an employee does not mirror the values of the business, such a candidate can be problematic although the candidate's skill set is ideal.

As can be seen there is a need for a method to reduce this type of mismatch by matching the core values of an employer and a prospective candidate.

### SUMMARY OF THE INVENTION

In one aspect of the present invention, a computer implemented method for matching prospective candidates to employers comprises using a computer for presenting at least one question to an employer and receiving an answer; using a computer for presenting at least one question to a prospective candidate and receiving an answer; and using a computer for creating an overall ranking of matching candidates and employers; wherein the at least one question presented to the employer and candidate pertains to core values of the candidates and employers.

In another aspect of the present invention, an alternative embodiment includes a computer implemented method for matching prospective candidates to employers comprising using a computer for presenting multiple questions to an employer and receiving answers; using a computer for presenting multiple questions to a prospective candidate and receiving answers; using a computer for creating an overall ranking of matching candidates and employers;

wherein the ranking is based on skill set first and core values second.

These and other features, aspects and advantages of the present invention will become better understood with reference to the following drawings, description and claims.

### BRIEF DESCRIPTION OF THE DRAWINGS

FIG. 1 is a flowchart illustrating an embodiment of the present invention.

FIG. 2 is a flowchart illustrating another embodiment of the present invention.

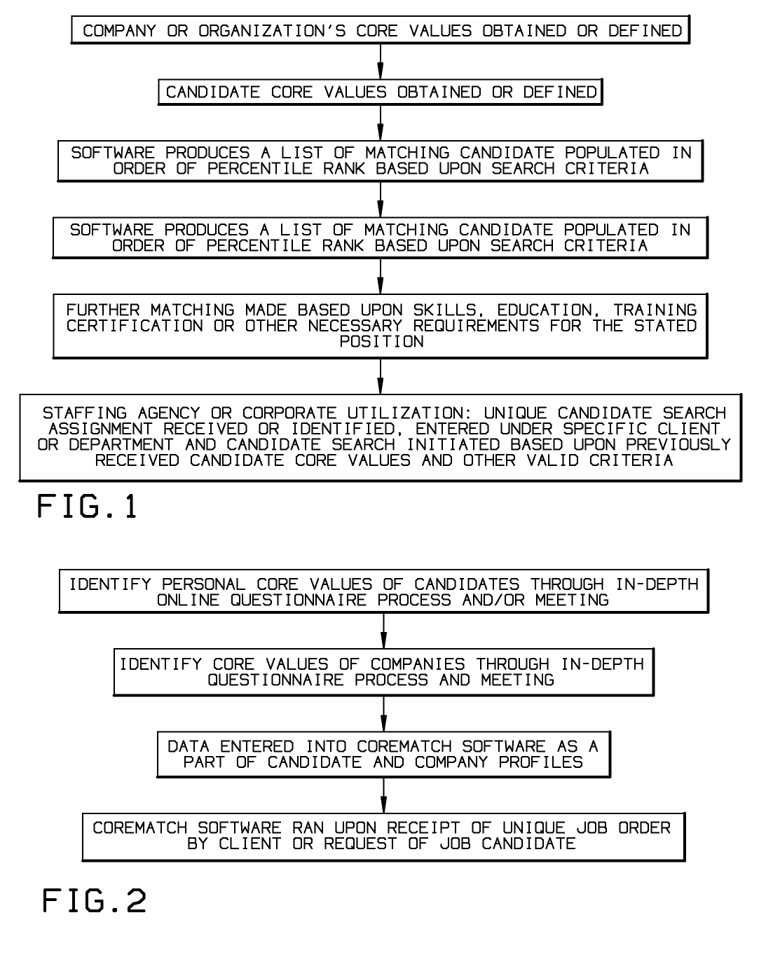

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides employers with the ability to match their core values to prospective employees and conversely, enable employees with their core values to that of prospective employers.

Core values are not descriptions of work that is performed or the strategies employed to accomplish a mission. The core values underlie the work, how various workers interact with each other, and which strategies are utilized to fulfill the mission. The core values are the basic elements of how work is performed. Core values are the practices used in daily tasks. Core values are traits or qualities that are considered not just worthwhile, they represent an individual's or an organization's highest priorities, deeply held beliefs, and core, fundamental driving forces. Core values define what an organization or individual believes. Core values are also called guiding principles because they form a solid core of who you are, what you believe, and who you are and want to be going forward.

Values form the foundation for everything that happens in the workplace. The core values of the employees in a workplace, along with their experiences, upbringing, and so on, meld together to form what is known as the corporate culture. The core values of the founder of an organization permeate the workplace. The founder's core values are powerful shapers of the organization's culture.

Core values, though not limited to the following, may include: accountability—responsibility of our actions that influence the lives of our customers and fellow workers; balance—maintaining a healthy life and work balance for workers; collaboration—collaborating within and outside the company effectively; commitment—commitment towards great products, service and other initiatives that impact lives both within and outside the organization; community—responsibility and contribution to society that define our existence; consistency—consistently offering the best for a wonderful experience; diversity—respecting the diversity and giving the best of the composition; efficiency—delivering an efficient and effective approach to give the best solution each time; empowerment—empowering the employees to take initiative; fun—having fun and celebrating small successes in our journey to achieve greater goals; innovation—developing new creative ideas; integrity—acting with honesty and integrity without compromising the truth; leadership—leading with courage to shape the future; ownership—taking ownership for the company and customer success; passion—putting the heart and mind in the work to get the best results; quality—giving the best and unmatched results to maximize satisfaction; respect—giving due respect to self and others and maintaining the environment of team work and growth; risk taking—encouraging risk taking to seize opportunities; safety—ensuring the safety of people and providing a trouble free experience; and service excellence—dedication to providing the best service.

The core values govern personal relationships, guide business processes and decisions, clarify and articulate a business's identity and helps explain what a business is about. Additionally, core values provide a guide on how to teach newcomers to the business, inform how employees of the business should be rewarded and reflect the total values of the business organization.

To assist employers in finding the ideal candidates, a core match questionnaire is provided to the prospective employer or client for determining the core values specific to their organization and culture of their workplace. A worksheet is used to establish those core values provided. Once the core values are obtained, that criteria will be entered into the organization's company profile in the software and will not change, although specific job/skills criteria may change for each position being recruited for. Although, companies and organizations may have more than one location, the core values will remain constant and only the culture of each office (i.e., casual clothing, etc) may change.

Each candidate/applicant/job seeker will be provided with the same questionnaire that the employer was provided with and an explanation of what specific core values are so the candidate may determine and ensure they are identifying their own core values as closely as possible. The candidate's identified core values will be stored as a part of their profile, along with skills, education, references, work history, experience, etc- creating a full candidate profile.

When a job order is received from a client company wishing to recruit new personnel, the match will then be made based upon a cross match of the core values of each, refined further by skills necessary to perform the necessary and essential job functions along with any location or office culture.

Core values of both employer and candidate are necessary to ensure a proper match and fit. New software users would have to ensure that a core match questionnaire is provided to existing candidates and employers and their answers input correctly prior to utilizing the matching software to ensure all candidates and employers are included in outcome.

An embodiment of the invention may include online questionnaires and videos for explaining what core values are to assist employers and prospective candidates in identifying their own core values.

Each step affords each participant (staffing or employment organization, candidate and employer) the ability to match employers and prospective candidates more closely than skills or personality based recruiting alone. When a matching algorithm is implemented, a skills based match could be run before matching the core values of the participants.

In an alternative embodiment, the matching algorithm can execute a core value match first before matching the skill set of the participants.

The core match may be run alone or in conjunction with any other variable as set forth by the hiring authority or decision maker. The core match can be executed alone, for example, if one were to build a “pool” of select candidates for an employer's upcoming needs.

The core match may also be utilized to identify existing employees potentiality for promotion to supervisory, management or corporate leadership roles and responsibilities.

In an alternative embodiment, the core match could be reversed to identify employers of choice for career seekers. A reverse core match would ensure that the candidates match with an employer prior to making a job change, thus affording more knowledge and protection prior to that change.

Through necessary data entry of compiled information on both candidate and employer, a cross match is made through the software of those matching criteria and that ranked in order of closest match, in descending order.

Information that is provided by all candidates and employers would be entered into and stored electronically in a server.

Upon receipt of a candidate request or employer request, core match can be utilized to create an overall ranking of matching candidates or employers- depending upon which end user requested the report be ran.

The above-discussed embodiments include software that performs certain tasks. The software discussed herein may include script, batch, or other executable files. The software may be stored on a machine-readable or computer-readable storage medium, and is otherwise available to direct the operation of the computer system as described herein and claimed below. In one embodiment, the software uses a local or database memory to implement the data transformation and data structures. The local or database memory used for storing firmware or hardware modules in accordance with an embodiment of the invention may also include a semiconductor-based memory, which may be permanently, removably or remotely coupled to a microprocessor system.

The computer-based data processing system described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries.

It should be understood, of course, that the foregoing relates to exemplary embodiments of the invention and that modifications may be made without departing from the spirit and scope of the invention as set forth in the following claims.

What is claimed is:

1. A computer implemented method for matching prospective candidates to employers comprising:
using a computer for presenting at least one question to an employer and receiving an answer;
using a computer for presenting at least one question to a prospective candidate and receiving an answer;
using a computer for creating an overall ranking of matching candidates and employers;
wherein the at least one question presented to the employer and candidate pertains to core values of the candidates and employers.

2. The computer implemented method of claim 1, wherein the employer is presented with multiple questions that pertain to the skill set of the desired candidate and the core values of the employer.

3. The computer implemented method of claim 1, wherein the candidate is presented with multiple questions that pertain to the skill set of the candidate and the core values of the candidate.

4. A computer implemented method for matching prospective candidates to employers comprising:
using a computer for presenting multiple questions to an employer and receiving answers;
using a computer for presenting multiple questions to a prospective candidate and receiving answers;
using a computer for creating an overall ranking of matching candidates and employers;
wherein the ranking is based on core values first and skill set second.

5. A computer implemented method for matching prospective candidates to employers comprising:
using a computer for presenting multiple questions to an employer and receiving answers;
using a computer for presenting multiple questions to a prospective candidate and receiving answers;
using a computer for creating an overall ranking of matching candidates and employers;
wherein the ranking is based on skill set first and core values second.
